(19) United States
(12) Patent Application Publication
(10) Pub. No.: US 2009/0170458 A1
(43) Pub. Date: Jul. 2, 2009

(54) Method and Receiver for Identifying a Leading Edge Time Period in a Received Radio Signal

(76) Inventors: Andreas F. Molisch, Arlington, MA (US); Ismail Guvenc, Santa Clara, CA (US); Zafer Sahinoglu, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/995,394

(22) PCT Filed: Jul. 19, 2005
(86) PCT No.: PCT/US05/25476

§ 371 Date: May 29, 2008

(51) Int. Cl. H04B 17/00

(52) U.S. Cl. 455/226.1

(57) ABSTRACT

A method for identifying a leading edge time period of a received radio signal includes identifying a greatest energy time period in a sequence of time periods. The received radio signal has a greatest average energy in the greatest energy time period. The method also includes identifying a least energy time period in the sequence of time periods. The received radio signal has a least average energy in the least energy time period. Further, the method includes setting a threshold energy based on the greatest average energy and the least average energy, determining a number of window time periods based on a characteristic of a radio channel used by the received radio signal, and identifying as a leading edge time period an earliest time period that precedes the greatest energy time period within the number of window time periods. The received radio signal in the leading edge time period has an average energy greater than or equal to the threshold energy.

### CROSS REFERENCE TO RELATED APPLICATIONS

The present invention is related to PCT/US2005/013035, entitled METHOD AND SYSTEM FOR ESTIMATING TIME OF ARRIVAL OF SIGNALS USING MULTIPLE DIFFERENT TIME SCALES, filed Apr. 15, 2005 and PCT/US2005/013590, entitled TRANSMITTING SIGNALS FOR TIME OF ARRIVAL ESTIMATION, filed Apr. 22, 2005, each of which are incorporated by reference herein in their entirety.

### BACKGROUND OF THE INVENTION

1. Field of the Invention

The present invention relates generally to methods and apparatuses for determining a distance between a radio transmitter and receiver by accurately identifying a time-of-arrival (TOA) of a leading edge of a received radio signal, and more particularly to identifying a leading edge time period in a wireless personal area network (WPAN) according to the IEEE 802.15 standard.

2. Background of the Invention

There is a growing demand for location awareness and ranging in short-range communication networks, and applications exploiting these features will play an important role in future wireless markets. Further, a variety of control and monitoring applications (e.g., building automation, environmental and structural monitoring etc.) are likely to be developed using a vast number of short-range, networked wireless devices.

Recognizing these trends, the IEEE has established the IEEE 802.15.4a Task Group (TG), with the goal of developing a low complexity, low rate physical (PHY) layer standard with a precision ranging capability. The TG has adopted ultrawideband (UWB) as the underlying technology. Low complexity, and thus low cost, of the devices is an important goal of the standard, and therefore, the TG has selected to enable UWB-based ranging with noncoherent (energy detection) receivers. Though the performance (i.e., precision or reliability) of noncoherent receivers may be less than that of coherent devices, the reduced cost of noncoherent receivers may justify the tradeoff for many applications.

An advantage of using a UWB signal for ranging applications is that if the signal has a large relative bandwidth, then there is a higher probability that at least some of the frequency components of the transmit signal can penetrate through an obstacle. Thus, the probability of receiving significant energy in the quasi-line-of-sight component is larger in this case. An additional advantage of using a UWB signal for ranging applications is that a large absolute bandwidth makes fine time resolution of the received signal possible, which helps to identify the time-of-arrival (TOA) of the multipath components, and improves leading signal edge detection performance. Ranging based on the TOA of the first arriving multipath component (quasi-line-of-sight) is the method of choice for UWB-based ranging, as described in “Ultra Wideband Geolocation,” S. Gezici et. al., John Wiley & Sons, Inc., 2005, in Ultrawideband Wireless Communications, incorporated by reference herein in its entirety.

The detection performance of autocorrelation receivers (transmitted reference (TR) and differential (DF) schemes) is studied with respect to different synchronization accuracy levels in “Performance analysis of non-coherent UWB receivers at different synchronization levels,” N. He et al., in Proc. IEEE Int. Conf. Global Comm. (GLOBECOM), Montreal, Canada, November 2004, pp. 3517-3521, incorporated by reference herein in its entirety. Further, “Synchronization analysis for UWB systems with a low-complexity energy collection receiver,” A. Rabbahin et al., in Proc. IEEE Ultrawideband Syst. Technol. (UWBST), Kyoto, Japan, May 2004, pp. 288-292, which is incorporated by reference herein in its entirety, presents synchronization analysis of non-coherent UWB receivers for both additive white Gaussian noise (AWGN) and Saleh-Valenzuela channel models, and points out the suitability of non-coherent receivers to enable low cost wireless sensor devices. Low probability of intercept performance of a timehopping UWB system by using single and multiple energy detectors is described in “Detection performance of time-hopping ultrawideband LPI waveforms,” J. Yu et al., in Proc. IEEE Sarnoff Symp., Princeton, N.J., April 2005, incorporated by reference herein in its entirety.

A backward search from the peak received signal energy was described in “Ranging in a dense multipath environment using an UWB radio link,” J-Y. Lee and R. A. Scholtz, IEEE Trans. on Selected Areas in Communications, vol. 20, issue 9, pp. 1677-1683, December 2002 for a coherent receiver, where a generalized maximum likelihood (GML) method searches the delays and amplitudes of all the paths prior to the maximum energy path. However, the approach requires very high sampling rates, and is computationally costly. In order to decrease the receiver complexity, a simple thresholding technique is mentioned in “Problems in modeling UWB channels,” R. A. Scholtz and J. Y. Lee, in Proc. IEEE Asilomar Conf. Signals, Syst. Computers, vol. 1, Monterey, Calif., November 2002, pp. 706-711, but no details on threshold-setting methodology were presented. An approach using high sampling rates and a break-point estimation algorithm with a generalized likelihood ratio is described in “A ranging technique for UWB indoor channel based on power delay profile analysis”, C. Mazzucco, U. Spagnolini, and G. Mulas, in Proc. IEEE Vehic. Technol. Conf. (VTC), Milan, Italy, vol. 5, May 2004, pp. 2595-2599. However, that technique is based on the correlation matrix that arises due to pulse shape, which is only possible with sampling rates on the order of the Nyquist rate.

FIG. 11 is a block diagram of a background UWB ranging receiver that includes a signal energy collector 1130 and a maximum (max) energy detector that receive a received radio signal 1150. The signal collector 1130 produces a sequence of time period average energy values based on the received signal 1150 and signal parameters 1120. The received radio signal 1150 is produced from a transmitted signal 1140 that is received over a radio channel 1160. The max energy detector 1110 produces a TOA estimate 1100 of the leading edge of the received signal 1150.

FIG. 12 is a detailed block diagram of a background signal energy collector 1130. The signal energy collector 1130 includes a low noise amplifier (LNA) 1210 that amplifies the received signal 1150, a band-pass filter (BPF) 1220 that filters the amplified signal, a signal correlator 1230 and integrator 1240 that collect and average the received energy of the filtered signal over a sequence of time periods, determined by signal parameters 1120. The signal parameters include, for example, bandwidth, frame interval, and symbol length of the received signal 1150. The signal energy collector 1130 also includes a sampler circuit 1250 that samples the averaged received energy in each time period and provides the averaged received energy to the max energy detector 1110. The background max energy detector 1110 identifies the time period having the maximum average received energy as the leading edge of the received signal. For example, as shown in the time period signal diagram of FIG. 13, which shows received energy per time period as determined by the background signal energy collector 1130, the background max energy detector 1110 may identify time period 1310 as being the leading edge of the received signal, because time period 1310 has a greater average energy than other time periods, for example greater than time period 1320.

### SUMMARY OF THE INVENTION

However, the present inventors recognized that in a typical non line of sight channel, the first arriving multipath signal component (MPC) may have less energy than the strongest received signal component and may arrive earlier than the strongest received signal component. Thus, it may not be accurate to identify the time period having the maximum average received energy as the leading edge of the received signal.

According to one embodiment of the present invention there is provided a novel method for identifying a leading edge time period of a received radio signal. The method includes identifying a greatest energy time period in a sequence of time periods, the received radio signal having a greatest average energy in the greatest energy time period; identifying a least energy time period in the sequence of time periods, the received radio signal having a least average energy in the least energy time period; setting a threshold energy based on the greatest average energy and the least average energy; determining a number of window time periods based on a characteristic of a radio channel used by the received radio signal; and identifying as a leading edge time period an earliest time period that precedes the greatest energy time period within the number of window time periods, and the received radio signal in the leading edge time period having an average energy greater than or equal to the threshold energy.

According to another embodiment of the present invention there is provided a novel method for identifying a leading edge time period of a received radio signal. The method includes identifying a greatest energy time period in a sequence of time periods, the received radio signal having a greatest average energy in the greatest energy time period; and identifying as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.

According to another embodiment of the present invention there is provided a novel receiver configured to identify a leading edge time period of a received radio signal. The receiver includes a receiving section configured to identify a greatest energy time period in a sequence of time periods, the received radio signal having a greatest average energy in the greatest energy time period; an identifying section configured to identify a least energy time period in the sequence of time periods, the received radio signal having a least average energy in the least energy time period; a setting section configured to set a threshold energy based on the greatest average energy and the least average energy; a determining section configured to determine a number of window time periods based on a characteristic of a radio channel used by the received radio signal; and a leading edge identifying section configure to identify as a leading edge time period an earliest time period that precedes the greatest energy time period within the number of window time periods, and the received radio signal in the leading edge time period having an average energy greater than or equal to the threshold energy.

According to another embodiment of the present invention there is provided a novel receiver configured to identify a leading edge time period of a received radio signal. The receiver includes a greatest energy identifying section configured to identify a greatest energy time period in a sequence of time periods, the received radio signal having a greatest average energy in the greatest energy time period; and a leading edge identifying section configured to identify as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.

According to another embodiment of the present invention there is provided a novel computer program product storing a program which when executed by a processor in a receiver configured to identify a leading edge time period of a received radio signal causes the processor to perform identifying a greatest energy time period in a sequence of time periods, the received radio signal having a greatest average energy in the greatest energy time period; identifying a least energy time period in the sequence of time periods, the received radio signal having a least average energy in the least energy time period; setting a threshold energy based on the greatest average energy and the least average energy; determining a number of window time periods based on a characteristic of a radio channel used by the received radio signal; and identifying as a leading edge time period an earliest time period that precedes the greatest energy time period within the number of window time periods, and the received radio signal in the leading edge time period having an average energy greater than or equal to the threshold energy.

According to another embodiment of the present invention there is provided a novel computer program product storing a program which when executed by a processor in a receiver configured to identify a leading edge time period of a received radio signal causes the processor to perform identifying a greatest energy time period in a sequence of time periods, the received radio signal having a greatest average energy in the greatest energy time period; and identifying as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a receiver according to an embodiment of the present invention;

FIG. 2 is a block diagram of a signal energy edge detector according to an embodiment of the present invention;

FIG. 3 is a time period waveform diagram according to an embodiment of the present invention;

FIG. 4A is an energy histogram and quadratic curve fit of a PDF vs. leading block energy;

FIG. 4B is a graph of CDF vs. leading block energy;

FIG. 5 a time period waveform diagram according to an embodiment of the present invention;

FIG. 6A is a graph of CDF vs. MER;

FIG. 6B is a graph of CDF vs. Delay;

FIG. 7 is a block diagram of a receiver according to another embodiment of the present invention;

FIG. 8 is a block diagram of another signal energy edge detector according to an embodiment of the present invention;

FIG. 9 a time period waveform diagram according to another embodiment of the present invention;

FIG. 10A is a histogram of PDF vs. number of signal clusters;

FIG. 10B is a histogram of PDF vs. delay between clusters;

FIG. 11 is a block diagram of a background receiver;

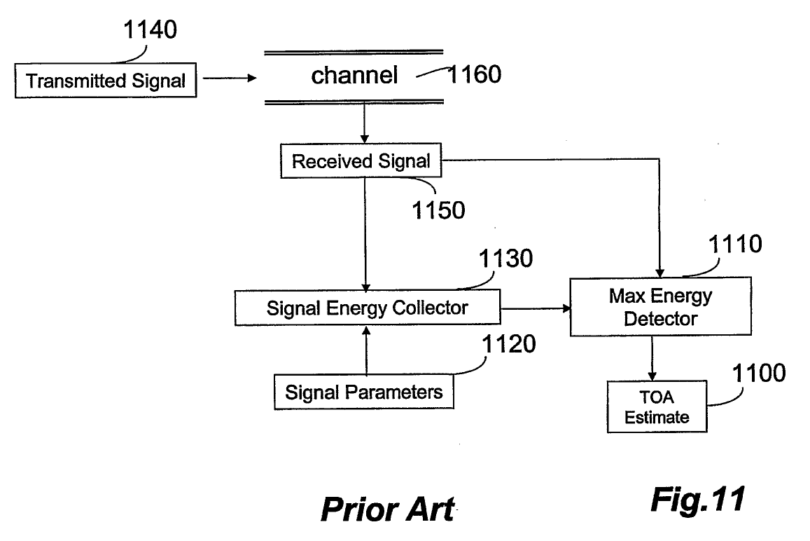

FIG. 12 is a block diagram of a background signal energy collector; and

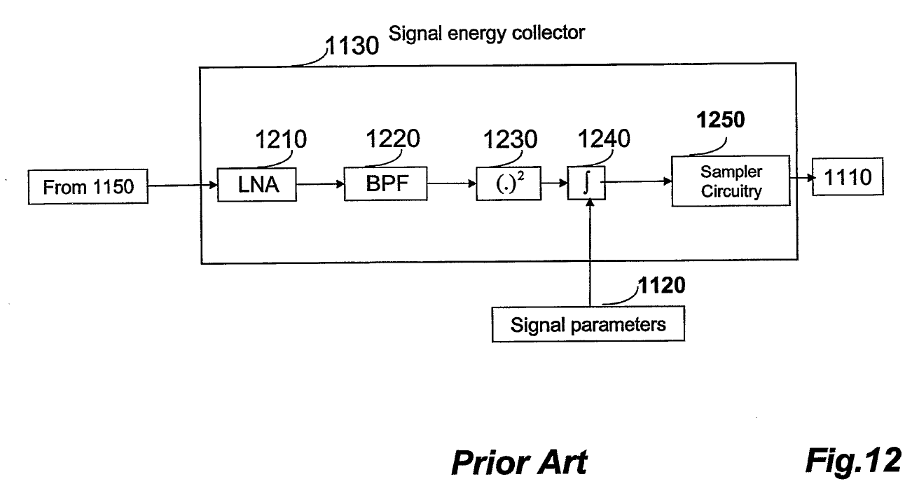

FIG. 13 is a background time period waveform diagram.

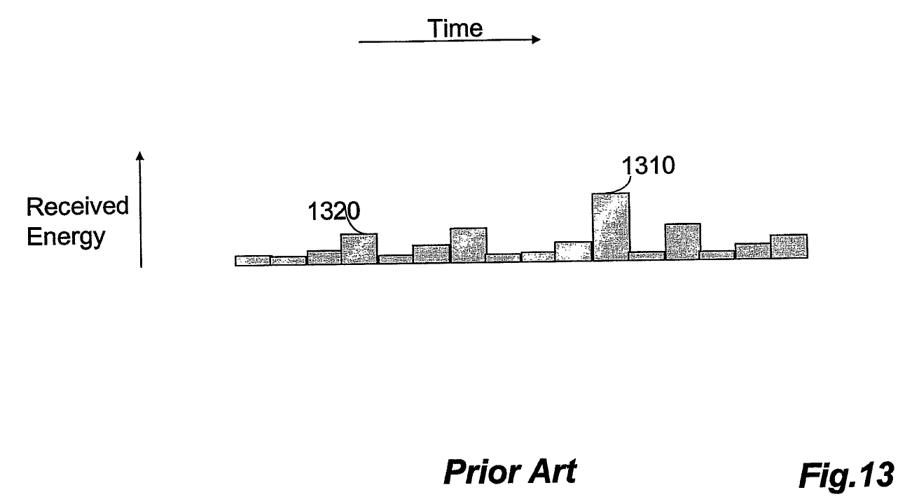

### DESCRIPTION OF THE PREFERRED EMBODIMENTS

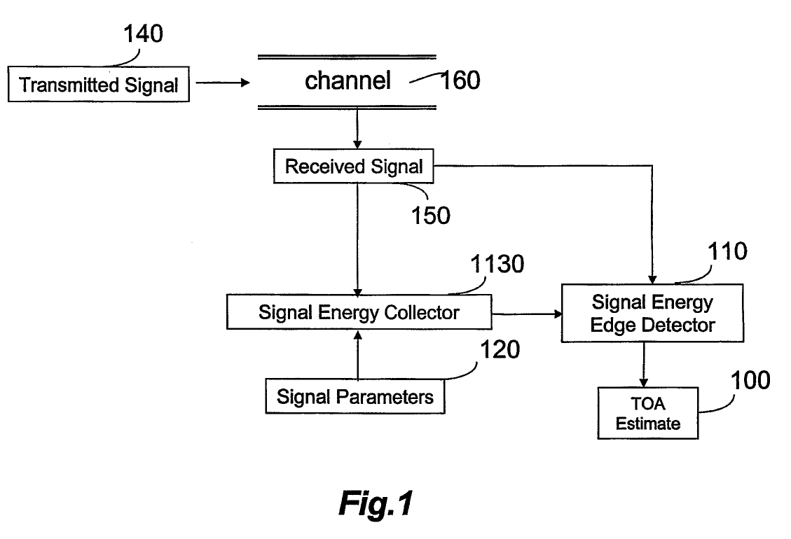

Referring to further of the drawings, wherein like reference numerals designate identical or corresponding parts throughout the several views, and more particularly to FIG. 1 thereof, FIG. 1 shows a block diagram of a receiver according to an embodiment of the present invention. The receiver includes a signal energy edge detector 110 that receives the received signal 150 and the average energy of the received signal in each time period as determined by the signal energy collector 1130. The signal energy collector 1130 and the signal energy edge detector 110 receive the received signal 150, which results from transmission of the transmitted signal 140 over the radio channel 160. The signal energy edge detector produces a TOA estimate 100.

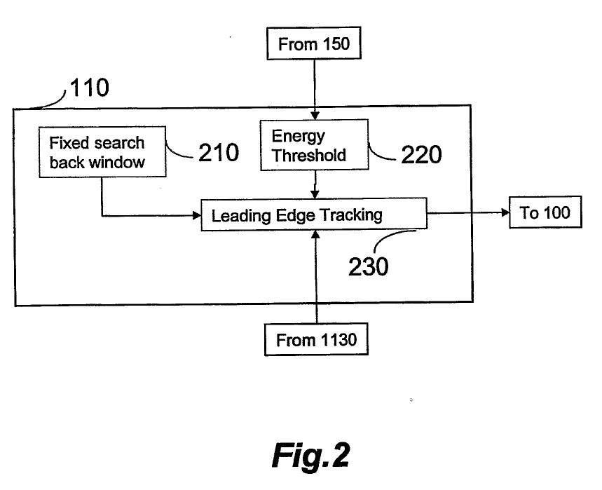

FIG. 2 is a detailed block diagram of the signal energy edge detector 110 that includes a fixed search back window section 210, energy threshold section 220 and leading edge tracking section 230. The energy threshold section 220 sets an energy threshold level and the fixed search back window section 210 sets a search back window size, each based on a statistical characteristic of the delay between the first signal energy component (i.e., the leading edge) and a greatest energy component of the received signal 150 and a ratio of their magnitude. Based on inputs from the fixed search back window 210 and the energy threshold 220, the leading edge tracking section 230 identifies the leading edge time period and determines the TOA to be the time of the identified leading edge time period, as described below.

Threshold selection according to the present embodiment may be achieved by setting the thresholds based on a normalized value between minimum and maximum energy samples. In this technique, the threshold is based on both the signal and noise energy levels, and does not require any parameter estimation.

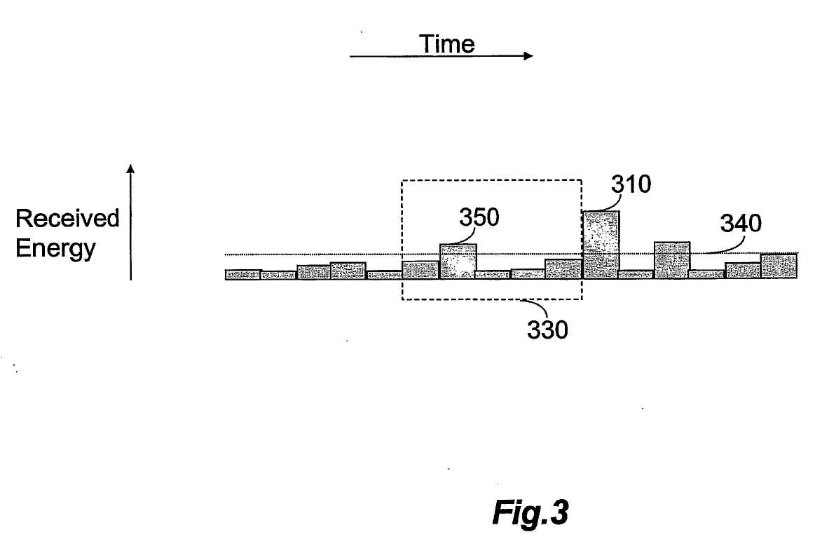

FIG. 3 is a time period waveform diagram showing an example output time period waveform of the signal energy collector 1130. In this example, the fixed search back window section 210 determines the fixed search back window 330 to be five time periods in duration. Further, the energy threshold section 220 sets an energy threshold 340 based on a ratio between the minimum and maximum energy levels of the received signal 150. For example, the threshold may be a normalized value between the minimum and maximum energy samples. The signal energy in time period 310 is determined by the leading edge tracking section 230 to be the time period having the greatest energy. The signal in time period 350 is identified as the leading edge of the received signal by the leading edge tracking section 230 because the signal in time period 350 is the first (i.e., earliest in time) time period within the fixed search back window 330 that has an energy greater than the energy threshold 340.

As determined by the present inventors, an accurate estimation of TOA includes estimation of the leading edge. Thus, samples prior to receipt of the greatest energy component of the received signal are searched and distinguished from the noise level, by the present invention. However, the received signal in the leading edge time period in a typical non-line of sight channel may be 6 dB less than the strongest component, and the leading edge may arrive up to 60 ns earlier as noted in “IEEE 802.15.4a channel model—final report,” A. F. Molisch et al., “Ieee 802.15.4a channel model—final report,” Tech. Rep. Document IEEE 802.15-04-0662-02-004a, 2005, incorporated herein by reference in its entirety.

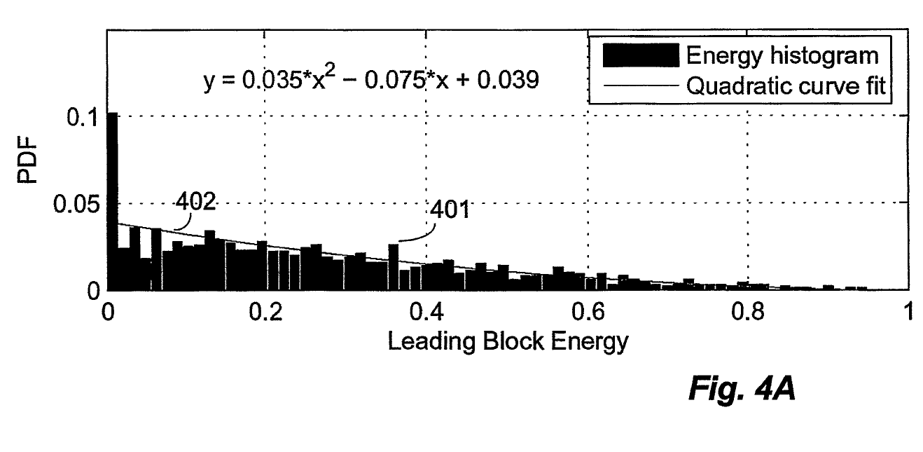

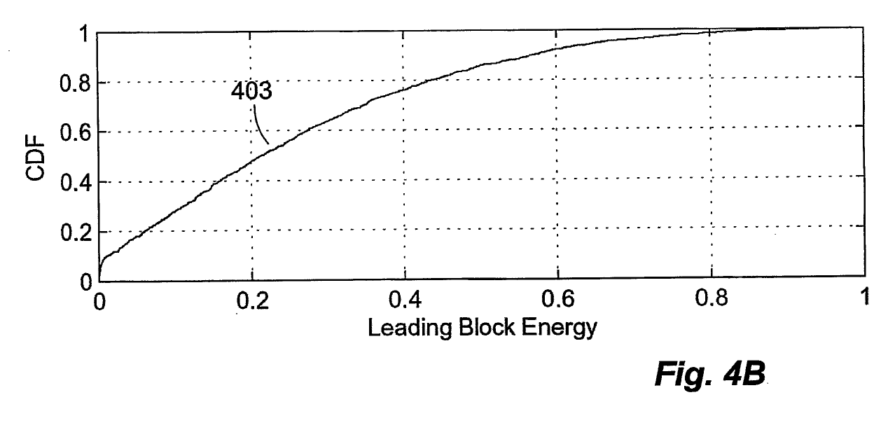

FIG. 4A shows a probability density function 401 of the energy in the leading edge energy time period and a corresponding quadratic curve fit 402. FIG. 4B shows a cumulative distribution function (CDF) 403 of the energy of the leading edge block for a commercial radio channel CM1, described by Molish et al. These figures indicate that about 10% of the time, the energy in the leading edge is very small compared to the transmitted energy for CM1. Thus, relatively weak leading edges, compared to the maximum energy peak, can be missed.

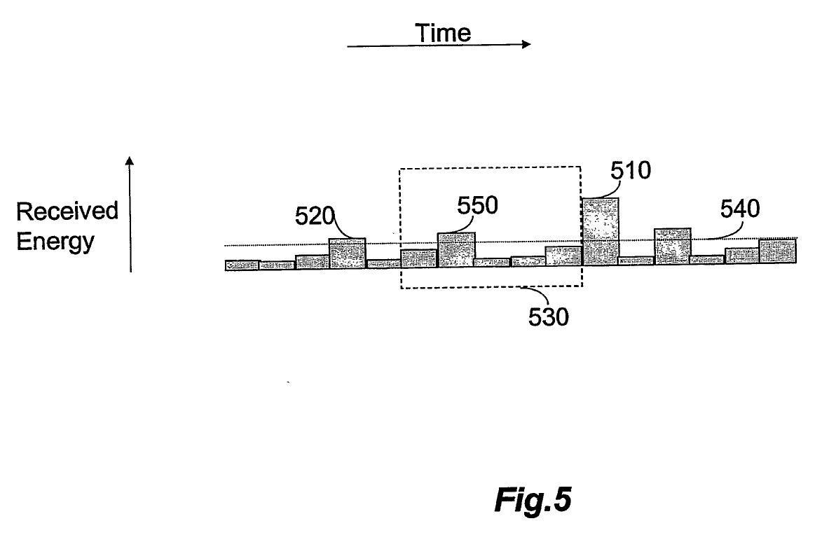

For example, FIG. 5 shows an example of a time period 520 including signal energy that arrives seven time periods earlier than the peak energy time period 510 and has an energy greater than an energy threshold 540. With the embodiment described above, if the fixed search back window section 210 sets a duration of the search back window 530 to only five time periods, then the true leading edge of the signal, in time period 520, may be missed by that embodiment, and time period 550 may be incorrectly identified as the leading edge time period.

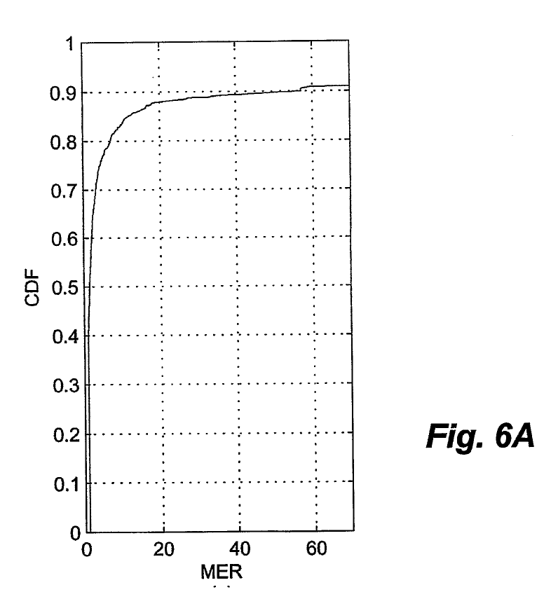

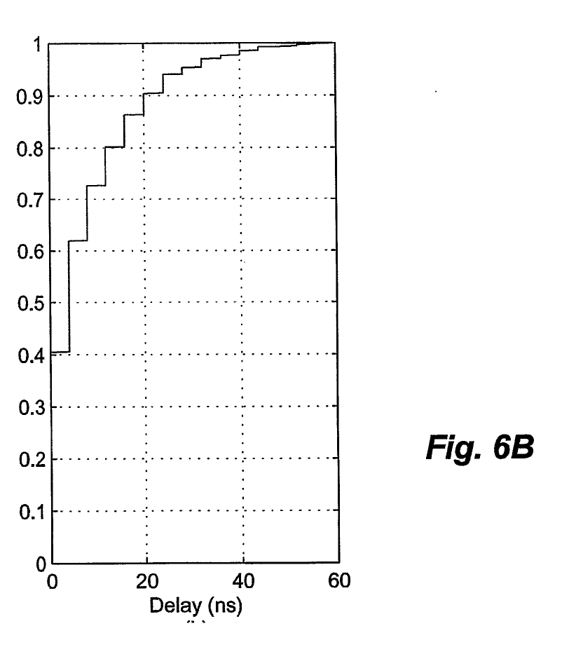

FIG. 6A shows a cumulative distribution function (CDF) of the maximum energy to leading edge energy ratio (MER) for 1000 CM1 channel realizations. Because only a small portion of the leading pulse energy is contained in the leading energy block, the MER may be as large as 40 dB (not shown on plot), and is smaller than 16 dB with 90% probability. Therefore, setting the normalized threshold to −16 dB will miss 10% of the leading edge blocks in a noise free channel. On the other hand, FIG. 6B shows that the delay between the peak and the leading edge may be as large as 60 ns for CM1. Thus, in that example, a fixed search back window duration may be as large as 60 ns to include the leading edge time period.

Thus, a further embodiment of the present invention addresses the drawbacks of the embodiment described above. In this further embodiment, the energy threshold is set based on the noise level, which may be estimated prior to leading edge detection. If μ_{ed} and σ_{ed}² are the mean and the variance of the noise samples that are at the output of the energy detector, then the probability of erroneously interpreting a noise sample as a signal sample may be expressed as

$${P}_{fa} = Q ( \frac{ξ - {μ}_{ed}}{{σ}_{ed}} ) , \qquad ( 1 )$$

where ξ denotes a threshold, μ_{ed} is the mean of the noise-only samples, and σ_{ed}² is the variance of the noise-only samples and Q denotes the Q-function, shown in equation 1A, which is used to describe the area under the tail of the Gaussian PDF, as described in “Digital Communications,” J. G. Proakis, McGraw-Hill, 4th Edition, NY, 2001, incorporated by reference herein in its entirety.

$$Q ( x ) = \frac{1}{\sqrt{2 π}} {\int }_{x}^{∞} {e}^{- {t}^{2} / 2} d t \qquad ( 1 A )$$

Before any processing gain due to multiple pulses per symbol, or multiple symbols, these parameters may be expressed as μ_{ed}=Mσₙ² and σ_{ed}²=2Mσₙ⁴, where M=2Btₛ is the degree of freedom determined by the signal bandwidth (determined by the band-pass filter) and the sampling rate. By fixing P_{fa}, the threshold ξ can be calculated from Equation (1) as

ξ=σ_{ed}Q⁻¹(P_{fa})+μ_{ed}. (2)

If there are no empty (i.e., noise-only) samples between the leading edge and the peak, then the present embodiment can successfully track samples until the leading edge, and the leading block estimate is given by

\hat{n}=min{n|\tilde{z}ₙ>ξ and \tilde{z}ₙ₋₁<ξ}+nₘₓ−w_{sb}, (3)

where nₘₓ is the sample index for the peak energy, and the search back vector is given by

\tilde{z}=└zₙ_{ₘₓ}_{-w}_{_{sb}}zₙ_{ₘₓ}_{-w}_{_{sb}}₊₁ . . . zₙ_{ₘₓ}┘, (4)

and w_{sb} is a search-back window that is set based on the statistics of the channel.

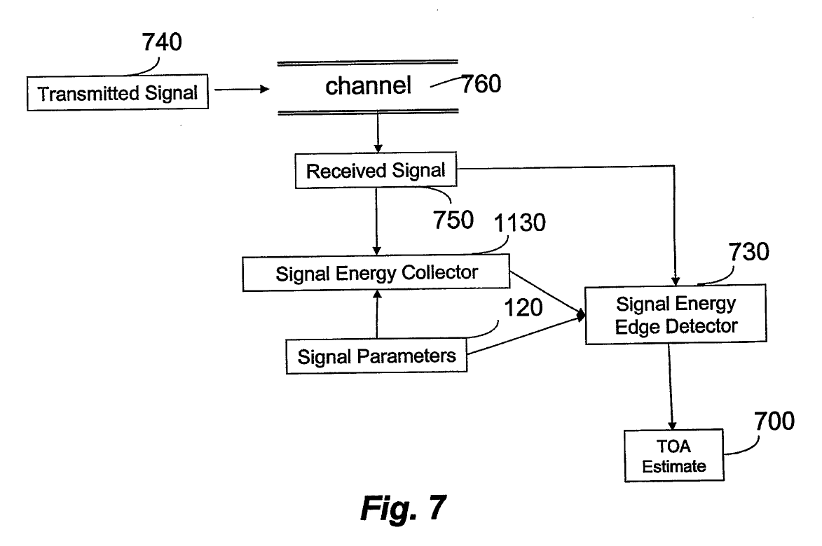

FIG. 7 is a block diagram of a receiver according to one embodiment of the invention. The receiver includes a signal energy collector 1130 similar to that of the preceding embodiment of FIG. 1, and a signal energy edge detector 730 that receives the received signal 750 based on the transmitted signal 740 as received over the channel 760 used by the received signal 750. The signal energy edge detector 730 also receives information from the signal energy collector 1130 and signal parameters 120. The signal energy detector 730 produces a TOA estimate 700.

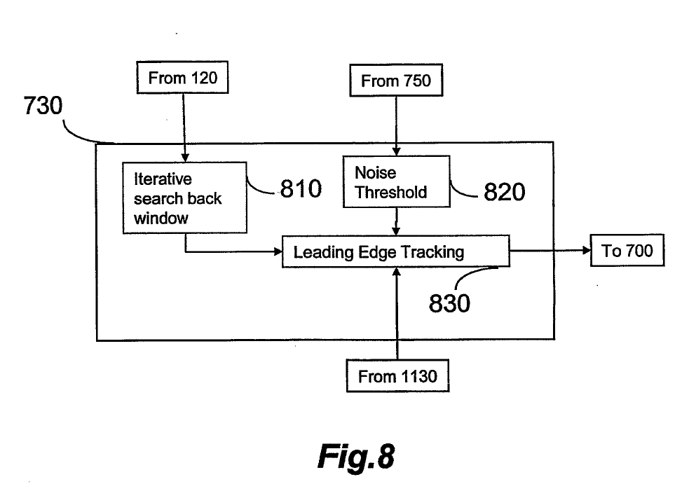

FIG. 8 is a detailed block diagram of the signal energy edge detector 730 according to the present embodiment. The signal energy edge detector 730 includes an iterative search back window section 810 that receives signal parameters 120, a noise threshold section 820 and a leading edge tracking section 830 that receives information from the signal energy collector 1130. According to the present embodiment the noise threshold section 820 sets the energy threshold according to a noise level of the received signal 750. The iterative search back window section 810 iteratively sets the size of the search back window according to a characteristic of the radio channel used by the received signal and a desired probability that a time period containing only noise (i.e., no signal) will be received prior to the time period having the greatest energy and having an energy level greater than the threshold, as described above and as further described below.

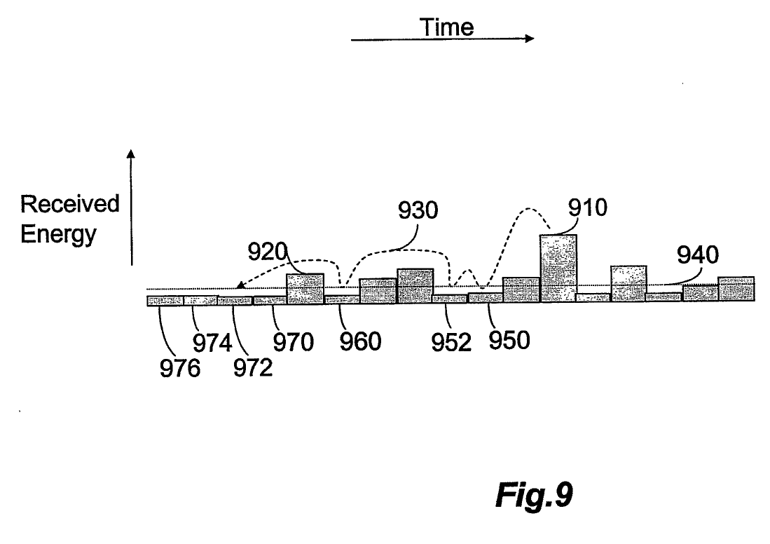

FIG. 9 is a time period waveform diagram showing energy values of time periods in the received signal as produced by the signal energy collector 1130 in the present embodiment. In addition, FIG. 9 shows the iterative search back window 930. In this example, the noise threshold section 820 has set the energy threshold 940 based on a noise level of the received signal 750 and leading edge tracking section 830 has identified time period 910 as the time period containing the greatest energy. The iterative search back window section 810 searches back through time periods preceding the time period having the greatest energy 910 to find the leading edge time period having the leading edge of the received signal. The iterative search window searches for the first group of n adjacent time blocks having a received energy level less than the threshold energy 940, where n is a size of the iterative search window. The size is determined by the iterative search back window section 830. The block immediately following that low adjacent time period group, which has an energy greater than or equal to the threshold, is identified as the leading edge time period. Thus, in the example of FIG. 9, where the iterative search window size is three, time periods 950/952 form a group of only two time periods, time period 960 forms a group of only one time period, and time periods 970/972/974/976 form the first group of more than three adjacent time periods having an energy level less than the threshold. Therefore, the time period 920 that immediately follows the adjacent time period group 970/972/974/976 is identified as the leading edge time period, according to the present embodiment.

The received multipath components in typical line-of-sight UWB channels usually arrive at the receiver in multiple clusters, i.e., groups of MPCs that are separated by noise-only samples.

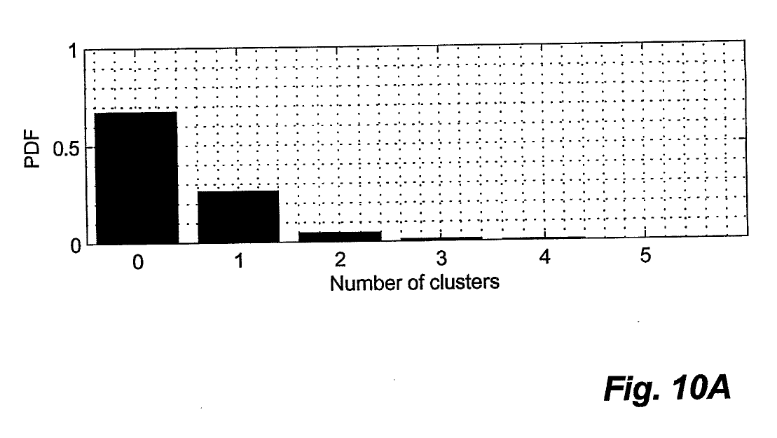

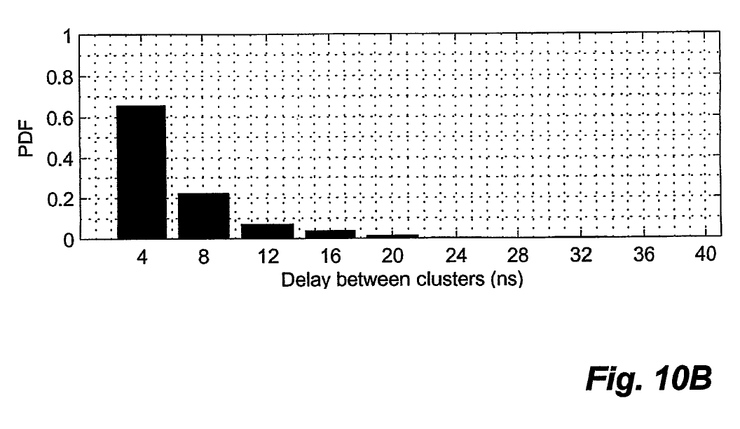

FIG. 10A shows the probability density function (PDF) of the number of signal clusters prior to the peak sample for a radio channel CM1, and FIG. 10B shows the PDF of the delays between any two signal clusters if there is at least one cluster prior to the peak energy sample, for Tₚ=tₛ=4 ns. Because the statistics show that there may be delays as large as 20 ns between the clusters, the preceding embodiment may lock to a sample that arrives later than the leading edge.

Thus, a further embodiment of the present invention accounts for multiple consecutive occurrences of noise samples to address the above described clustering problem. The false alarm probability when K multiple consecutive noise samples are considered can be determined according to

$${P}_{fa} = 1 - {[ 1 - Q ( \frac{ξ - {μ}_{ed}}{{σ}_{ed}} ) ]}^{K} , \qquad ( 5 )$$

which leads to a threshold given by

$$ξ = {σ}_{ed} {Q}^{- 1} ( 1 - {( 1 - {P}_{fa } )}^{\frac{1}{K}} ) + {μ}_{ed} . \qquad ( 6 )$$

The leading edge estimation of the present embodiment is then determined as follows

ñ=min {n|\tilde{z}ₙ>ξ and max{\tilde{z}ₙ₋₁,\tilde{z}ₙ₋₂, . . . , \tilde{z}_{max(n-k,1)}}<ξ}+nₘₓ−w_{sb}. (7)

Further, there is a problem when a signal in a time period before the first true multipath component (MPC) is incorrectly interpreted as carrying the first MPC. Because the (noise) energy contained in that time period is high, the noise is incorrectly interpreted as a signal component. The probability of this occurrence depends on the threshold between signal and noise. The higher the threshold is above the mean noise level, the lower is the probability of mistaking noise as signal. On the other hand, a high threshold also means that the probability increases that a weak first component is not detected.

Due to the clustering of multipath components, an important factor in setting the threshold is a determination of a number of noise-only time periods that can occur between time periods having signal energy. According to the current embodiment, the search for the leading edge starts at the maximum signal position, and then searching back in time to locate the first time period with noise only (i.e., below the threshold). If the propagation channel is ‘dense’, i.e., each time period corresponding to delays between tau_min and tau_max contains signal energy, then finding the first ‘noise-only’ time period in this backward search results in information about the arrival time of the first signal component, as the time period encountered in the backwards search just before the ‘noise-only’ time period. However, due to the clustering effect, there can be noise-only time periods, even between tau_min and tau_max. Thus, it may be necessary to continue the search even after finding the first ‘noise-only’ time period.

The number of time periods to continue searching is preferably limited. In that case, it is likely that a noise-only time period having energy greater than a threshold will be mistaken as a signal containing time period. Thus, the present embodiment limits the length of this ‘search back window’, according to statistical properties of the radio channel. In other words, the invention determines a maximum number of ‘empty’ time periods (i.e., time periods without a signal component) that lie between different signal clusters at a predetermined sampling rate. Note that the present embodiment only examines time periods that occur between the signal cluster with the first MPC, and clusters that contain the time period with the strongest energy. This information can come from channel models, or from previous measurements in a similar channel environment.

Further, the present embodiment seeks the time period with the first MPC with a certain probability, e.g., 90%. To achieve this, the embodiment insures that the probability of having an ‘erroneous’ first component (i.e., a noise-only time period containing more energy than a threshold) within the search back window is below the inverse of the desired probability, e.g., the probability is 10%. If there are other factors that can lead to an erroneous determination of the time of arrival, then this probability is selected even lower. The threshold between noise-only and signal-containing time periods may be selected in such a way that the probability of an above-threshold noise energy within any of the time periods within the search back window is below 10%. The longer the search back window, the higher the selected threshold.

The signal or channel statistical characteristics upon which the threshold and search back window parameters are selected may include a number of signal clusters, a delay between signal clusters and a duration of signal clusters.

The present invention includes processing of received signals, and programs by which the received signals are processed. Such programs are typically stored and executed by a processor in a wireless receiver implemented in VLSI. The processor typically includes a computer program product for holding instructions programmed and for containing data structures, tables, records, or other data. Examples are computer readable media such as compact discs, hard disks, floppy disks, tape, magneto-optical disks, PROMs (EPROM, EEPROM, flash EPROM), DRAM, SRAM, SDRAM, or any other magnetic medium, or any other medium from which a processor can read.

The computer program product of the invention may include one or a combination of computer readable media to store software employing computer code devices for controlling the processor. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

While the invention has been described with reference to exemplary embodiments thereof, it is to be understood that the invention is not limited to the exemplary embodiments in any way and that the invention is intended to cover all the various modifications and equivalent steps which one of ordinary skill in the art would appreciate upon reading this specification.

1. A method for identifying a leading edge time period of a received radio signal, comprising:
identifying a greatest energy time period in a sequence of time periods, the received radio signal having a greatest average energy in the greatest energy time period;
identifying a least energy time period in the sequence of time periods, the received radio signal having a least average energy in the least energy time period;
setting a threshold energy based on the greatest average energy and the least average energy;
determining a number of window time periods based on a characteristic of a radio channel used by the received radio signal; and
identifying as a leading edge time period an earliest time period that precedes the greatest energy time period within the number of window time periods, and the received radio signal in the leading edge time period having an average energy greater than or equal to the threshold energy.

2. The method of claim 1, wherein the setting further comprises setting the threshold energy based on a normalized value between the greatest average energy and the least average energy.

3. A method for identifying a leading edge time period of a received radio signal, comprising:
identifying a greatest energy time period in a sequence of time periods, the received radio signal having a greatest average energy in the greatest energy time period; and
identifying as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.

4. The method of claim 3, further comprising:
identifying a mean noise energy level and a noise energy variance of a radio channel used by the received radio signal; and
setting the threshold energy based on identified mean noise energy level and the noise energy variance of the radio channel.

5. The method of claim 4, wherein the setting further comprises:
setting the threshold energy ξ, according to the following equation:
ξ=σ_{ed}Q⁻¹(P_{fa})+μ_{ed}
wherein μ_{ed} is mean noise energy level, σ_{ed} is identified noise energy variance, P_{fa} is a probability of incorrectly identifying the leading edge time period, and Q is
$$Q ( x ) = \frac{1}{\sqrt{2 π}} {\int }_{x}^{∞} {e}^{- {t}^{2} / 2} d t .$$

6. The method of claim 4, wherein the setting further comprises:
setting the threshold energy ξ, according to the following equation:
$$ξ = {σ}_{ed} {Q}^{- 1} ( 1 - {( 1 - {P}_{fa } )}^{\frac{1}{K}} ) + {μ}_{ed}$$
wherein μ_{ed} is mean noise energy level, σ_{ed} is identified noise energy variance, P_{fa} is a probability of incorrectly identifying the leading edge time period, and Q is
$$Q ( x ) = \frac{1}{\sqrt{2 π}} {\int }_{x}^{∞} {e}^{- {t}^{2} / 2} d t .$$

7. The method of claim 3, further comprising:
predicting a number of signal clusters preceding the greatest energy time period based on a radio channel used by the received radio signal; and
setting the number of adjacent low energy time periods based on the number of signal clusters.

8. The method of claim 3, further comprising:
predicting a delay between signal clusters based on a radio channel used by the received radio signal; and
setting the number of adjacent low energy time periods based on the delay between signal clusters.

9. The method of claim 3, further comprising:
predicting a number of time periods per signal cluster based on a radio channel used by the received radio signal; and
setting the number of adjacent low energy time periods based on the number of time periods per signal cluster.

10. A receiver configured to identify a leading edge time period of a received radio signal, comprising:
a receiving section configured to identify a greatest energy time period in a sequence of time periods, the received radio signal having a greatest average energy in the greatest energy time period;
an identifying section configured to identify a least energy time period in the sequence of time periods, the received radio signal having a least average energy in the least energy time period;
a setting section configured to set a threshold energy based on the greatest average energy and the least average energy;
a determining section configured to determine a number of window time periods based on a characteristic of a radio channel used by the received radio signal; and
a leading edge identifying section configure to identify as a leading edge time period an earliest time period that precedes the greatest energy time period within the number of window time periods, and the received radio signal in the leading edge time period having an average energy greater than or equal to the threshold energy.

11. The receiver of claim 10, wherein the threshold setting section further comprises:
a normalized value setting section configured to set the threshold energy based on a normalized value between the greatest average energy and the least average energy.

12. A receiver configured to identify a leading edge time period of a received radio signal, comprising:
a greatest energy identifying section configured to identify a greatest energy time period in a sequence of time periods, the received radio signal having a greatest average energy in the greatest energy time period; and
a leading edge identifying section configured to identity as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.

13. The receiver of claim 12, further comprising:
a noise identifying section configured to identify a mean noise energy level and a noise energy variance used by a radio channel used by the received radio signal; and
a threshold setting section configured to set the threshold energy based on identified mean noise energy level and the noise energy variance of the radio channel.

14. The receiver of claim 13, wherein the threshold setting section further comprises:
a threshold determining section configured to determine the threshold energy ξ, according to the following equation:
ξ=σ_{ed}Q⁻¹(P_{fa})+μ_{ed}
wherein μ_{ed} is mean noise energy level, σ_{ed} is identified noise energy variance, P_{fa} is a probability of incorrectly identifying the leading edge time period, and Q is
$$Q ( x ) = \frac{1}{\sqrt{2 π}} {\int }_{x}^{∞} {e}^{- {t}^{2} / 2} d t .$$

15. The receiver of claim 13, wherein the threshold setting section further comprises:
a threshold determining section configured to determine the threshold energy ξ, according to the following equation:
$$ξ = {σ}_{ed} {Q}^{- 1} ( 1 - {( 1 - {P}_{fa } )}^{\frac{1}{K}} ) + {μ}_{ed}$$
wherein μ_{ed} is mean noise energy level, μ_{ed} is identified noise energy variance, P_{fa} is a probability of incorrectly identifying the leading edge time period, and Q is
$$Q ( x ) = \frac{1}{\sqrt{2 π}} {\int }_{x}^{∞} {e}^{- {t}^{2} / 2} d t .$$

16. The receiver of claim 12, further comprising:
a cluster predicting section configured to predict a number of signal clusters preceding the greatest energy time period based on a radio channel used by the received radio signal; and
a time period setting section configured to set the number of adjacent low energy time periods based on the number of signal clusters.

17. The receiver of claim 12, further comprising:
a cluster predicting section configured to predict a delay between signal clusters based on a radio channel used by the received radio signal; and
a time period setting section configured to set the number of adjacent low energy time periods based on the delay between signal clusters.

18. The receiver of claim 12, further comprising:
a cluster predicting section configured to predict a number of time periods per signal cluster based on a radio channel used by the received radio signal; and
a time period setting section configured to set the number of adjacent low energy time periods based on the number of time periods per signal cluster.

19. A computer program product storing a program which when executed by a processor in a receiver configured to identify a leading edge time period of a received radio signal causes the processor to perform:
identifying a greatest energy time period in a sequence of time periods, the received radio signal having a greatest average energy in the greatest energy time period;
identifying a least energy time period in the sequence of time periods, the received radio signal having a least average energy in the least energy time period;
setting a threshold energy based on the greatest average energy and the least average energy;
determining a number of window time periods based on a characteristic of a radio channel used by the received radio signal; and
identifying as a leading edge time period an earliest time period that precedes the greatest energy time period within the number of window time periods, and the received radio signal in the leading edge time period having an average energy greater than or equal to the threshold energy.

20. A computer program product storing a program which when executed by a processor in a receiver configured to identify a leading edge time period of a received radio signal causes the processor to perform:
identifying a greatest energy time period in a sequence of time periods, the received radio signal having a greatest average energy in the greatest energy time period; and
identifying as the leading edge time period a latest time period preceding the greatest energy time period immediately following a number of adjacent low energy time periods, the received radio signal having an average energy greater than or equal to a threshold energy in the leading edge time period, and the received radio signal having an average energy less than the threshold energy in each of the adjacent low energy time periods.
